(19) United States
(12) Patent Application Publication
(10) Pub. No.: US 2011/0146488 A1
(43) Pub. Date: Jun. 23, 2011

(54) Atmospheric Carbon Dioxide Mitigation

(75) Inventor: Jeffrey David Jacob, Palmdale, CA (US)

(73) Assignee: Aerospatia LLC, Mojave, CA (US)

(21) Appl. No.: 12/646,960

(22) Filed: Dec. 23, 2009

(51) Int. Cl. B01D 53/62; B01D 53/04

(52) U.S. Cl. 95/139

(57) ABSTRACT

A regenerative process for the capture, sequester, and negative ionization of carbon dioxide for expulsion of the species within a geomagnetic polar region for subsequent treatment by high frequency electromagnetic radiation.

### RELATED APPLICATIONS

U.S. Pat. No. 3,659,400; Filing date Jul. 21, 1970; Related use of Polyethyleneimine as CO2 adsorption and desorption agent

U.S. Pat. No. 4,046,529 Filing date May 21, 1976; Related use of Amberlite XAD7 beads coated with Polyethyleneimine as CO2 adsorption and desorption agent

U.S. Pat. No. 6,703,785 Filing date Jun. 19, 2002; Related use of piezoelectric transformer in avoidance of electromagnetic discharge during negative ion generation

### BACKGROUND OF THE INVENTION

1. Field of the Invention
1. This invention relates to a process for the capture and sequestering of carbon dioxide molecules from an incoming air flow, and subsequent negative ionization of the species for effective release within a geomagnetic polar region, where the fair weather electric field and atmospheric convection manifest acceleration of the species upward for further treatment by ground based high frequency [HF] transmitters which expel the species permanently from the earth's atmosphere.

2. Prior Art
2. There have existed several methodologies for mitigating rising levels of carbon dioxide within ambient air in small scale environment enclosures. From the use of the chemisorbent material lithium hydroxide [LiOH] in the early days of America's space program [NASA Projects Mercury, Gemini, Apollo] to the regenerative carbon dioxide removal systems currently used for the space shuttle program, and international space station. Though these systems were applicable to small scale environments, none of these were considered as a scalable solution to remediate the rising levels of CO2 within our atmosphere, primarily due to cost and scale for LiOH, and the fact that the regenerative removal systems expel the species back into the space vacuum without further treatment, which would be counterproductive for an atmospheric removal system.
An atmospheric CO2 removal system must be able to not only capture and sequester CO2, but in the expulsion mechanism, must effectively enable the species to exit our atmosphere. Based on research by Dr. Alfred Y. Wong, Professor of Experimental Plasma and Environmental Physics at UCLA, it has been proven that negatively charged CO2 ions can be accelerated by High Frequency electromagnetic fields that resonate at the ion's gyro frequency [above 120 KM] along the earth's open magnetic field lines. This physical potentiality necessitates a methodology that can effectively saturate these electromagnetic wave fields with negatively charged CO2 ions.
Our Atmospheric Carbon Dioxide Mitigation [ATCOM] process provides a valid methodology to accomplish this saturation requirement.

### SUMMARY OF THE INVENTION

The invention has an object of capturing and sequestering significant amounts of carbon dioxide molecules from an incoming air stream by directing flow into an airborne cylindrical carbon composite canister or ATCOM canister [approx 20 ft long and 5 ft in diameter] which has the capacity to capture, sequester, and then release the species with negative ionization within a desired High Frequency electromagnetic wave field transmitted within the auroral oval, and which resonates at the ion's gyro frequency.

The initial airflow into the ATCOM canister will be slowed to a specific flow velocity as the air stream travels through a volute chamber with resistance added impellers, and then into a free flow chamber where the incoming flow velocity compresses the air volume allowing for an osmotic equality distribution of the concentration of CO2 molecules.

Eventually, the pressure of the incoming air stream will direct the flow through a polyetheyleimine granule matrix [PGM], containing 20 wire mesh chambers [30-40 mesh U.S. Sieve Series] with XAD-7 coated polyetheyleimine beads.

Once a desired metric is captured, as indicated by the digital weight scale measuring the increased mass of the imine granules, a human user can initiate the release of the CO2 molecules through induction of a vacuum state within the sealed PGM chamber, and transfer the species to an ionization chamber where five electron emission spikes, consisting of stylus electric discharge electrodes with correspondent negative high voltage application, create an electron field which allow the attachment of an electron to the outer molecular shell of the species, effecting negative ionization.

The created electron field coupled with incoming air pressure within the Negative Ionization Chamber, expels the CO2-ions through the outflow duct, where the fair weather electric field and atmospheric convection cause the species to rise upward.

As the expulsion is coordinated to occur within the angular vector of a ground based transmitter's high frequency [HF] electromagnetic wave field resonating at the CO2-ion's gyro frequency, once the species reaches above 120 Km into the ionosphere, the transmission energy will accelerate the ions into space, from where they will not return to our atmosphere.

### BRIEF DESCRIPTION OF THE DRAWINGS

FIG. 1. Depicts an external side view of an implementation of the ATCOM process in an ATCOM canister.

FIG. 2. Depicts an external front view of an implementation of the ATCOM process in an ATCOM canister.

FIG. 3. Depicts an external rear view of an implementation of the ATCOM process in an ATCOM canister.

FIG. 4. Depicts a cutaway side view of an implementation of the ATCOM process in an ATCOM canister.

FIG. 5. Shows a cutaway view of an ATCOM canister integrated within a solar powered airship.

FIG. 6. Shows an enlarged view of the ATCOM canister integration within an airship from FIG. 5.

FIG. 7. Shows another cutaway perspective view of the integration of ATCOM canisters within a solar powered airship.

### DETAILED DESCRIPTION OF THE DRAWINGS

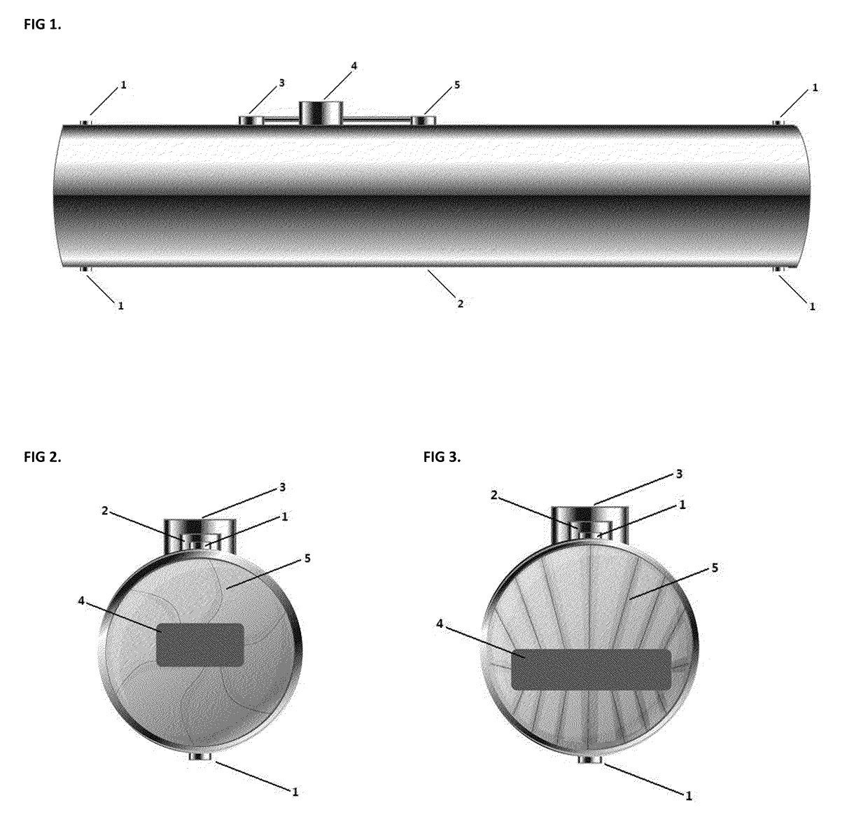

FIG. 1 depicts an external side view of an implementation of the ATCOM process as an ATCOM canister. 1.2 shows the long cylindrical carbon composite canister, with tab locks 1.1 to lock into specialized flexible viton rubber tubing connected to air flow inlets and outlets aboard an airship. Air flow mounts connected to vacuum pump 1.4, lead from the air flow mount 1.5, above the “Pure Air Chamber” through vacuum pump 1.4 and into air flow mount 1.3 above the “Negative Ionization Chamber”.

FIG. 2 depicts an external front view of an implementation of the ATCOM process as an ATCOM canister. 2.4 shows the Air Inflow Duct with sloped funnel design 2.5. Tab locks 2.1 lock into the front slots of specialized flexible viton rubber tubing connected to air flow inlets aboard an airship. Air flow mount 2.2 above the “Pure Air Chamber” connects to vacuum pump 2.3.

FIG. 3 depicts an external rear view of an implementation of the ATCOM process as an ATCOM canister. 3.4 shows the Air Inflow Duct with sloped funnel design 3.5. Tab locks 3.1 lock into the rear slots of specialized flexible viton rubber tubing connected to air flow outlets aboard an airship. Air flow mount 3.2 above the “Negative Ionization Chamber” connects to vacuum pump 3.3.

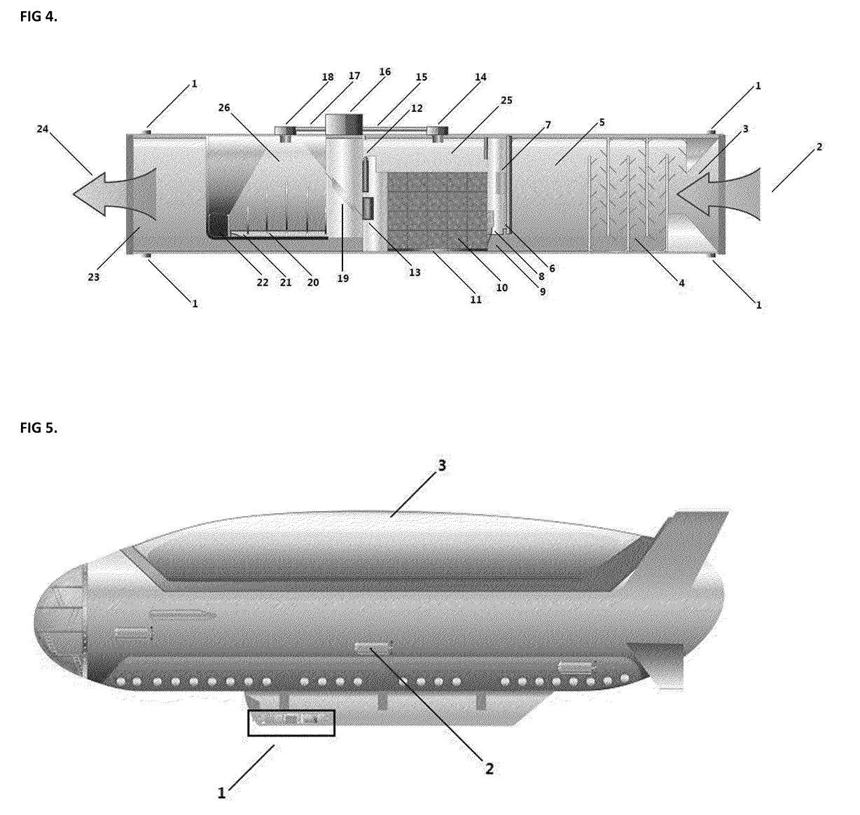

FIG. 4 shows a cutaway side view of the ATCOM process implemented as an ATCOM Canister. 4.1 indicates the four tab locks that lock into flexible viton tubing at both ends. 4.2 represents an incoming airflow, and 4.2 shows the Air Inflow Duct.

4.4 shows the volute chamber with resistance added impellers to slow incoming airflow to a flow velocity of no more than 556.16 Ft3/sec. [Flow velocity set by impellers=8 MPH=approx 704 Ft/Min; Airflow output duct radius=0.5 ft; Duct Cross Section=π*radius of output duct squared=3.1415*[0.5 ft]2=approx 0.79 square feet; Cubic Feet per Minute [CFM]=704 ft/ min*0.79 ft2=556.16 ft3/Min]

4.5 depicts a “Free Flow Air Chamber” which effects a brief spiral circulation of the incoming air flow, until the chamber volume is filled with air. This manifests an effective osmotic distribution of the air content, namely the 0.038% of the ambient air stream consisting of carbon dioxide, and additional air inflow will force the stream into the Polyethyleneimine Granule Matrix in 4.10.

4.10 shows the Polyethyleneimine Granule Matrix [PGM], which consists of twenty separate rectangular wire mesh chambers [30-40 mesh U.S. Sieve Series], containing granules made of an inert substrate [Amberlite XAD7 marketed by Rohm and Haas Company] coated with an active agent [Polyethyleneimine]. Polyethyleneimine is known in the prior art as a sorption agent of carbon dioxide at standard temperature and pressure, and to desorb within a vacuum state.

4.25 depicts the “Pure Air Chamber” which contains the volume of space that the purified air will flow into once it has traveled through each of the twenty chambers within the PGM. The air flowing into this chamber is virtually free of carbon dioxide.

4.19 shows a one way flow tube, through which purified air exiting the Pure Air Chamber 4.25 enters into, and flows through exiting the Outflow Duct depicted in 4.23 as a CO2 free airstream 4.24.

4.11 represents a digital weight scale with programmable logic processor 4.8. As the airflow travels into the PGM 4.10 through entrance 4.9, carbon dioxide molecules are captured and sequestered, causing a subsequent increase in the mass of the imine granules. Once the imine granules increase in weight by 215 kg [approx 474 Lbs], this will cause an ICMP data packet to be sent to the logic processor in 4.8, which is programmed to close the two chamber doors depicted 4.6 and 4.12 upon receipt of the data packet.

The two sliding chamber doors [4.6 at the entrance of the PGM; 4.12 at the exit of the Pure Air Chamber] are mechanically activated by generators 4.7 and 4.13 which form an airtight seal on both sides.

4.16 depicts a vacuum pump, which is connected to air flow mounts 4.14 and 4.18 [above “Pure Air Chamber” 4.25 and “Negative Ionization Chamber” 4.26 respectively] via flow tubes 4.15 and 4.17. The vacuum pump is manually activated based on the input of a human user. This creates a partial vacuum state within the PGM 4.10 and Pure Air Chamber 4.25, which effects the release of the CO2 molecules from the PGM, and transfers them into the Negative Ionization Chamber depicted in 4.26.

4.30 shows the five Electron Emission Spikes within the Negative Ionization Chamber 4.26 which consist of five stylus electric discharge electrodes which are impressed with a high negative voltage, thus creating an electron field which effects the negative ionization of incoming CO2 molecules passing through the field. This process is initiated only by a human user who has given input to engage the vacuum pump depicted in 4.16. A piezoelectric transformer 4.22 is used as opposed to coil wrapped around an iron core to prevent electromagnetic wave discharge, which can counteract the negative ionization process, and even positively ionize the species.

4.21 represents flow ducts to a free airflow corridor directly beneath the ducts which lead into the Air Outflow Duct 4.23.

As the CO2 molecules become negatively ionized, they will become repelled downward in large part by the substantial electron field created by the Electron Emission Spikes 4.21, as well as forced through flow ducts 4.12 by incoming air pressure emanating from air flow mount 4.18.

After logic processor 4.8 indicates that the weight of PGM 4.10 [ as measured by digital weight scale 4.11] has returned to a molar mass free of CO2, it will signal generators 4.7 and 4.13 to reopen chamber doors 4.6 and 4.12, whereby the ATCOM process may be repeated.

FIG. 5 depicts a solar powered airship design with specialized engines 5.2, powered by a large region of thin solar film 5.3. Side cutaway view 5.1 shows the integration of an ATCOM canister within the lower region of the airship.

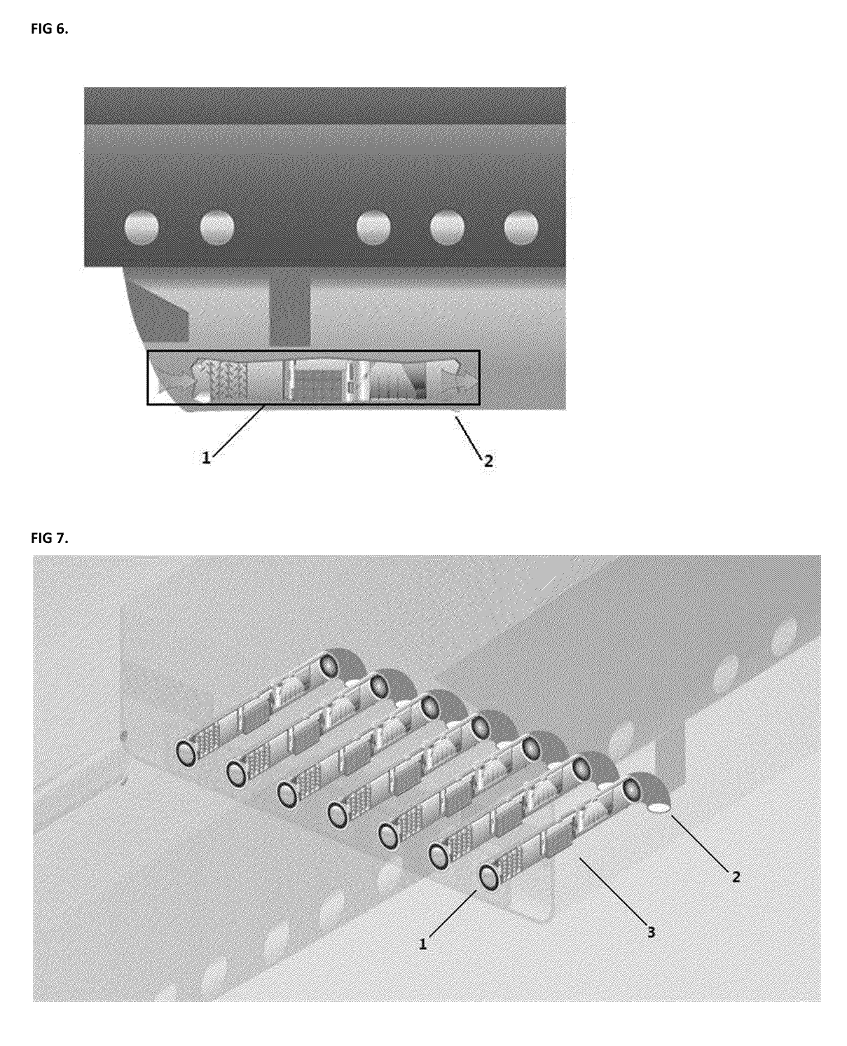

FIG. 6 shows enlarged view 6.1 of the cutaway view 5.1 above, and shows air outlet 6.2 at the bottom of the airship.

FIG. 7 shows cutaway perspective view 7.3 of the integration of seven ATOM canisters which are connected via flexible viton rubber tubing to air inlet 7.1 and air outlet 7.2.

This Substitute Specification contains no new matter.

What is claimed is:

1. A regenerative process that captures and sequesters carbon dioxide from an incoming air flow, with the ability to expel the species back into the atmosphere with negative ionization and within a desired geographic coordinate containing electromagnetic radiation that resonates at the negatively charged carbon dioxide ion's gyro frequency.
